(19) United States
(12) Patent Application Publication
(10) Pub. No.: US 2026/0208726 A1
(43) Pub. Date: Jul. 23, 2026

(54) NAVIGATION VISUALIZATION SYSTEM

(71) Applicant: TOYOTA JIDOSHA KABUSHIKI KAISHA, Toyota-Shi (JP)

(72) Inventor: SCOTT MICHAEL HARRIS, San Jose, CA (US)

(73) Assignee: TOYOTA JIDOSHA KABUSHIKI KAISHA, Toyota-Shi (JP)

(21) Appl. No.: 19/034,387

(22) Filed: Jan. 22, 2025

(51) Int. Cl. B60W 30/09; B60W 30/095; B60W 60/00; G08G 1/16

(52) U.S. Cl. CPC B60W 30/09; B60W 30/0953; B60W 30/0956; B60W 60/0015; G08G 1/16; B60W 2554/806; B60W 2556/10

(57) ABSTRACT

A system includes sensors that obtain sensor data of an ego vehicle and of an obstacle during operation of the ego vehicle. The system includes one or more processors, and a memory storing instructions that, when executed by the one or more processors, cause the system to perform operations. The operations include selectively characterizing the obstacle as a potential interfering obstacle based on the sensor data. Upon characterizing the obstacle as a potential interfering obstacle, an intended action of the ego vehicle is determined. A visual representation of an environment of the ego vehicle is generated. The visual representation includes a representation of the intended action of the ego vehicle. The visual representation is populated on an interface. The interface is associated with the ego vehicle or associated with an occupant of the ego vehicle.

### TECHNICAL FIELD

The present disclosure relates generally to visualization during navigation of a vehicle.

### DESCRIPTION OF RELATED ART

By 2040, an anticipated 75 percent of vehicles will be autonomous or semi-autonomous, according to the Institute of Electrical and Electronics Engineers (IEEE). Occasionally, an autonomous vehicle may perform unexpected navigation actions, which may cause a safety driver, passenger, or other operator of the autonomous vehicle to feel unsettled. This may cause safety drivers, passengers, and other operators of an autonomous vehicle to lack full confidence in the operations of an autonomous vehicle.

### BRIEF SUMMARY OF THE DISCLOSURE

According to various embodiments of the disclosed technology, a system comprises one or more sensors configured to obtain sensor data of an ego vehicle and of an obstacle during operation of the ego vehicle, the sensor data comprising navigation characteristics of the ego vehicle and the obstacle. The system also comprises one or more processors. The system comprises a memory storing instructions that, when executed by the one or more processors, cause the system to perform operations. The operations include selectively characterizing the obstacle as a potential interfering obstacle based on the sensor data. The operations further include, in response to characterizing the obstacle as a potential interfering obstacle, determining an intended action of the ego vehicle in response to the potential interfering obstacle; generating a visual representation of an environment of the ego vehicle, wherein the visual representation comprises a representation of the intended action of the ego vehicle; and populating the visual representation on an interface associated with the ego vehicle or associated with an occupant of the ego vehicle. In some embodiments, an interface associated with the ego vehicle may include or be within a dashboard or console (e.g., central console) within the ego vehicle. In some embodiments, an interface associated with the occupant may include an interface of a device that receives communications, such as regarding status updates, of the ego vehicle.

In some embodiments, the navigation characteristics comprising a relative position, a relative velocity, or a relative heading of the ego vehicle with respect to the obstacle.

In some embodiments, the potential interfering obstacle is characterized based on an inferred action or a historical behavior of the potential interfering obstacle with respect to the ego vehicle.

In some embodiments, the visual representation comprises a representation of the ego vehicle and a representation of the potential interfering obstacle.

In some embodiments, the generating of the visual representation comprises determining a portion of the representation of the potential interfering obstacle to be emphasized based on a relative position of the potential interfering obstacle with respect to the ego vehicle and emphasizing the determined portion of the representation of the potential interfering obstacle.

In some embodiments, the intended action comprises a change in a velocity of the ego vehicle.

In some embodiments, the intended action comprises one or more navigation actions to maintain a threshold distance from the potential interfering obstacle.

In some embodiments, the generating of the visual representation comprises overlaying the visual representation onto existing sensor data illustrating the environment of the ego vehicle.

In some embodiments, the instructions that, when executed by the one or more processors, cause the system to perform: at least partially autonomously implementing the intended action of the ego vehicle. For example, the implementing of the intended action may include sending one or more signals to one or more vehicle actuators to perform a navigation action, which causes the one or more vehicle actuators to be activated. In some embodiments, the implementing of the intended action may be performed in L2 mode.

In some embodiments, the selectively characterizing of the obstacle as a potential interfering obstacle is based on a relative distance between the obstacle and the ego vehicle.

In some embodiments, the obstacle comprises another vehicle, a human, or a nonhuman organism.

In some embodiments, a vehicle control system comprises a processor; and a memory coupled to the processor to store instructions, which when executed by the processor, cause the processor to perform operations. The operations include obtaining sensor data from one or more sensors, the sensor data comprising navigation characteristics of an ego vehicle and an obstacle; characterizing the obstacle as a potential interfering obstacle based on the sensor data; and in response to characterizing the obstacle as a potential interfering obstacle: determining an intended action of the ego vehicle in response to the potential interfering obstacle; generating a visual representation of an environment of the ego vehicle, wherein the visual representation comprises a representation of the intended action of the ego vehicle; and populating the visual representation on an interface located within the ego vehicle, associated with the ego vehicle, or associated with an occupant of the ego vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for detecting a potential interfering obstacle and generating a visual representation in response to detecting the potential interfering obstacle, in accordance with one embodiment of the systems and methods described herein.

FIGS. 4-5 illustrate example implementations of generating a visual representation in response to detecting the potential interfering obstacle, in accordance with one embodiment of the systems and methods described herein.

FIGS. 6-9 illustrate example implementations of generating a visual representation in response to detecting the potential interfering obstacle, in accordance with one embodiment of the systems and methods described herein. In particular, FIGS. 6 and 7 illustrate example implementations of an ego vehicle reacting to another merging vehicle. FIG. 7 illustrates an example implementation of cutting in and maintaining at least a threshold distance. FIG. 8 illustrates an example implementation of an ego vehicle maintaining a distance from another vehicle. FIG. 9 illustrates an example implementation of an ego vehicle cutting in front of a different vehicle behind while maintaining a distance from a different vehicle ahead.

FIGS. 10-13 are example flowcharts illustrating navigation actions and generating of visual representations in various navigation scenarios, in accordance with one embodiment of the systems and methods described herein.

FIG. 14 is an example computing component that may be used to implement various features of embodiments described in the present disclosure.

The figures are not exhaustive and do not limit the present disclosure to the precise form disclosed.

### DETAILED DESCRIPTION

A navigation system of an ego vehicle may obtain sensor data from one or more sensors. The ego vehicle may operate under different levels of autonomy, such as any of Society of Automotive Engineers (SAE) levels L1-L5. The sensor data may include characteristics of an obstacle. An obstacle may include another vehicle, a pedestrian, an organism (e.g., a living being besides a human), a moving obstacle besides an animal, or a stationary obstacle. The characteristics may include time-series data and/or may be indicative of navigation characteristics or predicted navigation characteristics, such as position, velocity, heading, acceleration, predicted position, predicted velocity, predicted heading, or predicted acceleration. In some embodiments, the sensor data may include characteristics of the ego vehicle itself.

Based on the sensor data, in particular, according to some aspects, based on the obstacle navigation characteristics or predicted obstacle navigation characteristics, the navigation system may detect a potential interfering obstacle. A potential interfering obstacle may be characterized as an obstacle that will affect, or has at least a threshold likelihood or probability of affecting, one or more navigation characteristics of the ego vehicle at a current time and/or within a future duration of time. As alluded to previously, the navigation characteristics of the ego vehicle may include a velocity, heading, acceleration, predicted or future velocity, predicted or future heading, or predicted or future acceleration of the ego vehicle.

Upon detecting the potential interfering obstacle, the navigation system may generate a visual output, visual image, or a visual representation (hereinafter “visual representation”) of an environment of the ego vehicle. The visual representation may include a potential interfering obstacle on an interface. The interface may include a human machine interface (HMI) in various locations of the ego vehicle, such as on a console (e.g., central console), dashboard, a front display, and/or a rear display. The visual representation may include an augmented or augmented reality (AR) representation of the ego vehicle. The visual representation may include a 2-dimensional (2D) or a 3-dimensional (3D) representation of the ego vehicle or an augmented layer atop a real-world representation or depiction. In some embodiments, the visual representation may be displayed on a 2D screen augmented and/or augmented on a 3D media (e.g., video) feed. In some embodiments, the visual representation may be represented within a device such as goggles (e.g., AR goggles or VR goggles) that provide a view through a windshield or other transparent or partially transparent surface of the ego vehicle. The visual representation may further include a representation of the ego vehicle and a representation of any navigation actions the ego vehicle is taking or will be taking.

In such a manner, the visual representation provides context and preparation for impending vehicle actions to an occupant with the ego vehicle. Examples of occupants may include passengers and safety drivers. The visual representation constitutes a technical benefit of an improved computing system which interacts with an occupant by translating otherwise undecipherable decisions by the ego vehicle, and one or more aspects or factors that affect the decisions, into visual representations which are easily understood by an occupant. This greatly increases the occupant's comfort level, understanding, and preparedness, which further enhances safety of the ego vehicle. By being more comfortable and informed, the occupant will also be able to make better decisions, for example, when changing the ego vehicle from autonomous to manual mode.

As another implementation, one or more sensors may, upon detection of a potential interfering obstacle, change one or more sensor parameters such as changing a zoom level. For example, one or more sensors may capture a potential interfering obstacle or a portion thereof. If current sensor parameters cannot fully capture the potential interfering obstacle, the one or more sensors may communicate with a vehicle processor (e.g., an electronic control unit (ECU)) regarding the potential interfering obstacle, and/or one or more obstacle parameters of the potential interfering obstacle. The vehicle processor may communicate with, and/or control the one or more sensors to change the one or more sensor parameters in order to fully capture the potential interfering obstacle and/or any contextual information associated with the potential interfering obstacle. For example, a camera may change a zoom level and/or otherwise adjust a perspective upon detecting a potential interfering object in front of or behind the ego vehicle, in order to accommodate a 3-D perspective between the ego vehicle and the potential interfering object.

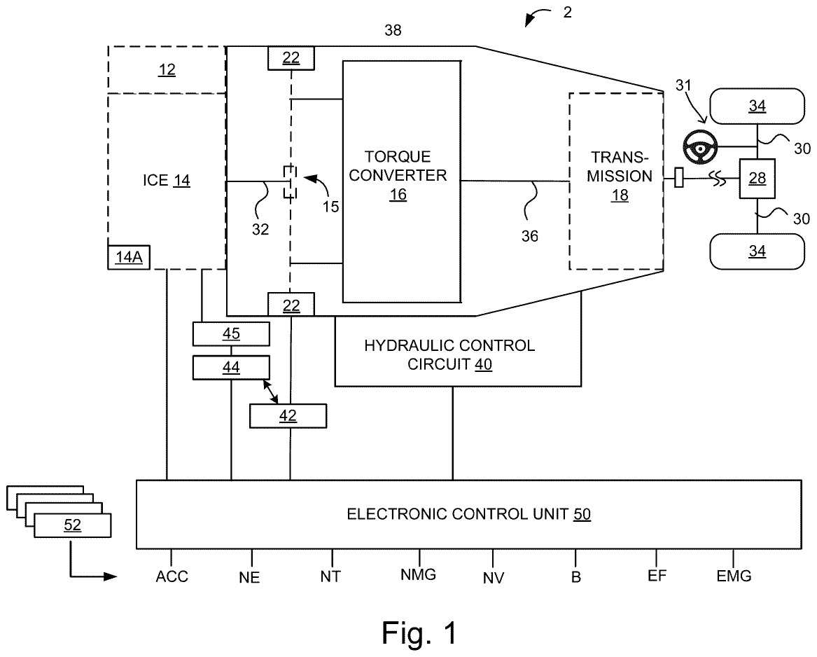

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for navigation visualization can be implemented in other types of ego vehicles including gasoline-or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. The ego vehicle 2 may include a steering system 31. The steering system 31 may be implemented via electronic power steering (EPS) or steer-by-wire.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and braking. As a more particular example, output torque of the motor 22 can be increased or decreased by electronic control unit 50 through the inverter 42. In some embodiments, the electronic control unit 50 may control the steering system 31.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2 or of an obstacle, such as another vehicle, pedestrian, animal, or other obstacle. Here, navigation characteristics may include an absolute position, an absolute velocity, an absolute heading, or an absolute acceleration of the ego vehicle 2 or of the obstacle. The navigation characteristics may also include a relative position, a relative velocity, a relative heading, or a relative acceleration of the ego vehicle 2 with respect to the obstacle.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of the obstacle, as well. Sensors that might be used to detect external conditions can include, for example, sonar, radar, lidar or other vehicle proximity sensors, and cameras or other image sensors. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior or on an exterior of the ego vehicle 2. The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

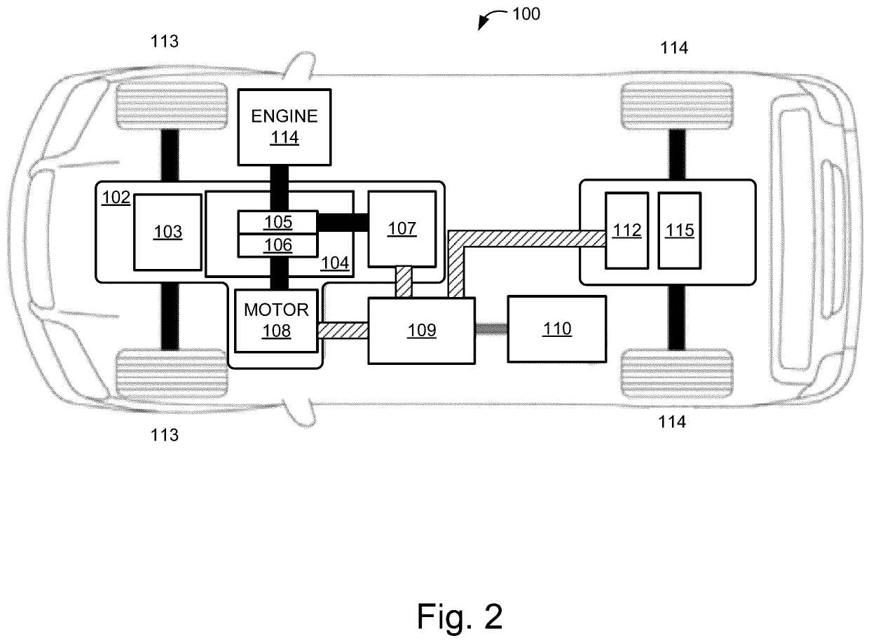

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

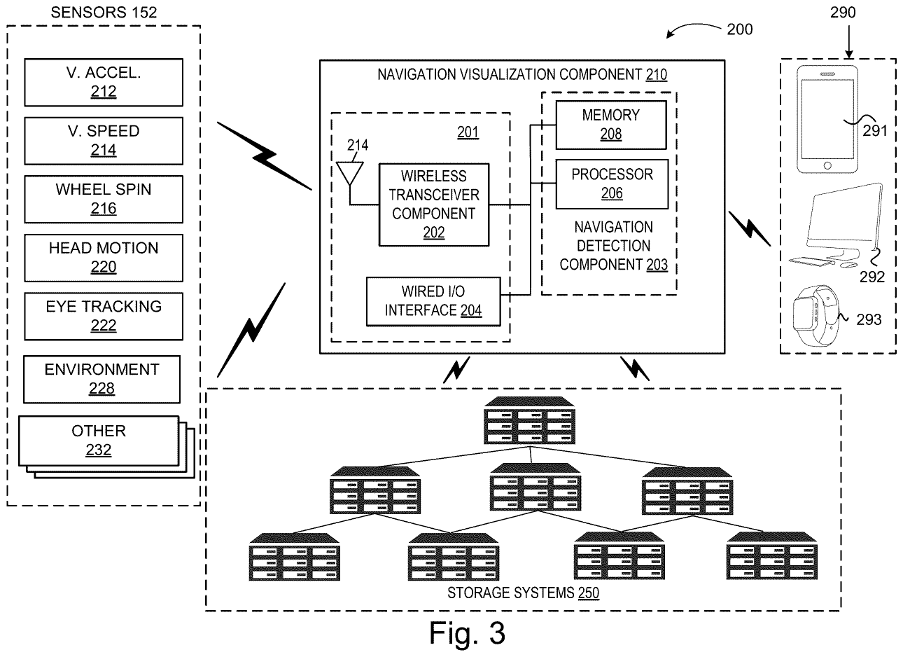

FIG. 3 illustrates an example architecture for adaptively and selectively generating a visualization representative of navigation of the ego vehicle 2, based on sensor data detected at least in part by sensors 52 illustrated in FIG. 1, in accordance with one embodiment of the systems and methods described herein. Referring now to FIG. 3, in this example, navigation visualization system 200 includes an obstacle detection component 203, which detects, using the sensor data, a potential interfering obstacle. A potential interfering obstacle includes any obstacle that is affecting, will affect within a threshold duration of time, or has at least a threshold likelihood to affect one or more navigation characteristics of the ego vehicle 2. A potential interfering obstacle may be detected on a basis of navigation characteristics of the potential interfering obstacle relative to the navigation characteristics of the ego vehicle and/or a type of the potential interfering obstacle. In some embodiments, a potential interfering obstacle includes another vehicle, a pedestrian, an organism besides a human, or another moving or stationary obstacle. As specific examples, the potential interfering obstacle includes another vehicle behind the ego vehicle 2 that is approaching and appearing likely to pass or cut in front of the ego vehicle 2, another vehicle to a side of the ego vehicle 2, and/or another vehicle in front of the ego vehicle 2.

The navigation visualization system 200 further includes a navigation visualization component 210. The navigation visualization component 210 generates a visual representation of an environment of the ego vehicle 2. The visual representation may be displayed at a location associated with the ego vehicle 2 or associated with an occupant of the ego vehicle 2. Possible locations include any of a console or a dashboard of the ego vehicle 2, on any interior display or virtual display, such as located behind front seats of the ego vehicle 2, or elsewhere within the ego vehicle 2. In some embodiments, the visual representation may be displayed on a separate device, such as on augmented reality (AR) or virtual reality (VR) goggles worn by an occupant of the ego vehicle 2. In some embodiments, the visual representation may include a 2-D or a 3-D representation.

The visual representation may include an image or other visual representation of the potential interfering obstacle, a visual representation of a current or future navigation action of the potential interfering obstacle, a representation of the ego vehicle 2, and/or an indication of a current or future navigation action of the ego vehicle 2 in response to the potential interfering obstacle. In some embodiments, a perspective and/or view of the visual representation of the potential interfering obstacle is adjusted based on one or more navigation characteristics of the potential interfering obstacle, such as a current position of the potential interfering obstacle relative to the ego vehicle 2. For example, upon detecting the potential interfering obstacle, one or more sensors of the ego vehicle 2 that are configured to capture the potential interfering obstacle may adjust a zoom level and/or an angle to sufficiently capture the potential interfering obstacle. Specifically, the one or more sensors may zoom out to fully capture the potential interfering obstacle.

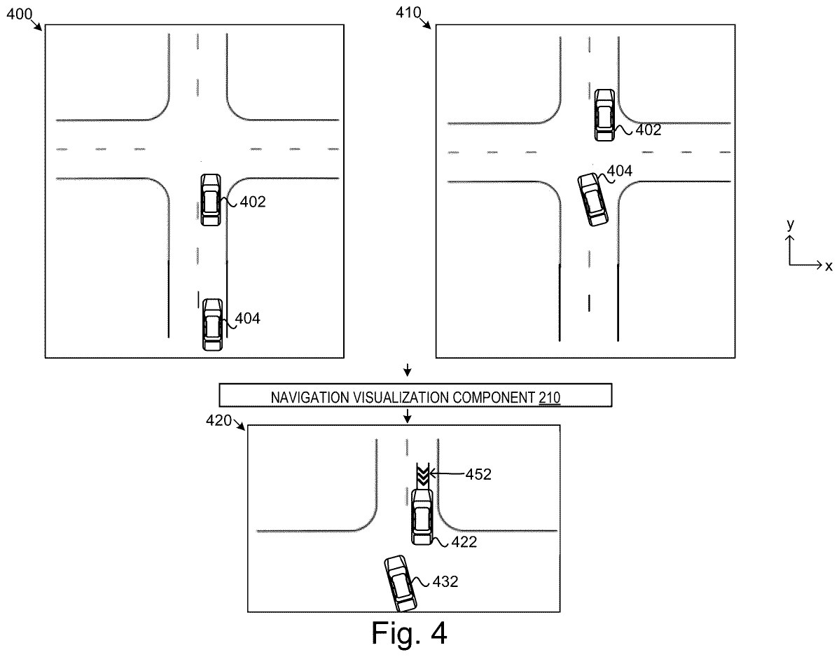

In some embodiments, the navigation visualization component 210 annotates, highlights, or otherwise emphasizes a portion of the potential interfering obstacle depending on one or more navigation characteristics of the potential interfering obstacle, such as a current position of the potential interfering obstacle relative to the ego vehicle 2. For example, if the potential interfering obstacle is behind the ego vehicle 2, the navigation visualization component 210 emphasizes a front portion of the potential interfering obstacle. If the potential interfering obstacle is in front of the ego vehicle 2, the navigation visualization component 210 emphasizes a rear portion of the potential interfering obstacle. If the potential interfering obstacle is on a side of the ego vehicle 2, the navigation visualization component 210 emphasizes a side of the ego vehicle 2 facing the ego vehicle 2. Example visual representations are illustrated in FIGS. 4-9.

Navigation visualization component 210 can be implemented as part of an ECU such as, for example electronic control unit 50. In other embodiments, navigation visualization component 210 can be implemented independently of or separately from the ECU. Navigation visualization component 210 in this example includes a communication component 201, and an obstacle detection component 203 (including a processor 206 and memory 208 in this example). Components of navigation visualization component 210 are illustrated as communicating with each other via a data bus, although other communication in interfaces can be included.

The navigation visualization system 200 may include a plurality of sensors 152, one or more storage systems 250 which may include remote servers, and one or more other devices 290 which may be external to or internally located within the ego vehicle 2. In some embodiments, the one or more other devices 290 include one or more different computing or mobiles devices 291, 292, 293 and may be configured to receive a subset (e.g., a portion or all of) outputs from the navigation visualization component 210, either in real-time or in a delayed manner via V2N communication. In some embodiments, the one or more other devices 290 may include AR/VR functionality such as AR/VR goggles or displays that display a visual representation of the potentially interfering obstacle. Sensors 152, storage systems 250, and one or more other devices 290 can communicate with the navigation visualization component 210 via a wired or wireless communication interface. Although sensors 152, storage systems 250 and one or more other devices 290 are depicted as communicating with navigation visualization component 210, they can also communicate with each other as well as with other vehicle systems.

The obstacle detection component 203 may detect an existence of a potential interfering obstacle by detecting surrounding obstacles and characterizing or categorizing (hereinafter “characterizing”) any of the surrounding obstacles as potentially interfering obstacles for any one or more of the surrounding obstacles that satisfy a potential interference criteria. In some embodiments, surrounding obstacles may include, and/or be selected from, obstacles within a threshold distance of the ego vehicle 2, and/or having a threshold level of visibility from a perspective of the ego vehicle 2. In some embodiments, the characterizing of any of the surrounding obstacles as potentially interfering obstacles may depend on one or more inferred types of an obstacle. The types may be inferred based on sensor data of the obstacle. The types may be inferred based on a navigation manner, navigation behavior, and/or navigation characteristics of the vehicle. Examples of such navigation characteristics include historical velocity data, current velocity data, historical acceleration data, and current acceleration data. In some embodiments, the types of the obstacle may include broader or general types, such as “vehicle,” “pedestrian,” “non-human animal,” “stationary obstacle,” or specific types of vehicles such as “truck,” “sedan,” “van,” “sport utility vehicle,” “authority vehicle,” “non-authority vehicle,” “aggressive vehicle,” and/or “passive vehicle.”

For example, if an obstacle is inferred to be an authority vehicle (e.g., an ambulance or police vehicle), the obstacle detection component 203 may be more likely to characterize the authority vehicle to be a potential interfering obstacle, and/or characterize the authority vehicle to be a potential interfering obstacle at a greater approaching distance. For instance, an authority vehicle may be characterized as a potential interfering obstacle when the authority vehicle approaches to within 200 feet of the ego vehicle 2. However, a non-authority vehicle may be characterized as a potential interfering obstacle when the non-authority vehicle approaches to within 100 feet of the ego vehicle 2. That is, a non-authority vehicle may be required to be within a closer distance to the ego vehicle 2 in order to be characterized as a potential interfering obstacle.

As another example, if an obstacle is inferred to be an aggressively behaving vehicle, the obstacle detection component 203 may be more likely to characterize the aggressively behaving vehicle to be a potential interfering obstacle, and/or characterize the authority vehicle to be a potential interfering obstacle at a greater approaching distance. In some embodiments, an aggressively behaving vehicle may be a vehicle that frequently changes lane, overtakes vehicles, and/or executes dangerous and/or aggressive maneuvers at a frequency above a threshold frequency.

For instance, an aggressively behaving vehicle may be characterized as a potential interfering obstacle when the aggressively behaving vehicle approaches to within 200 feet of the ego vehicle 2. However, a non-aggressively behaving vehicle or passively behaving vehicle may be characterized as a potential interfering obstacle when the passively behaving vehicle approaches to within 100 feet of the ego vehicle. That is, a passively behaving vehicle may be required to be within a closer distance to the ego vehicle 2 in order to be inferred as a potential interfering obstacle.

Returning to the navigation visualization system 200, the sensors 152 can include, for example, sensors 52 such as those described above with reference to the example of FIG. 1. Sensors 152 can include additional sensors. In the illustrated example, sensors 152 may obtain navigation characteristics and/or other related data such as behavioral and/or interaction data of one or more obstacles external to the ego vehicle 2, and/or of occupants within the ego vehicle 2. The sensors 152 may include vehicle acceleration sensors 212, vehicle speed sensors 214, wheelspin sensors 216 (e.g., one for each road wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions).

In some embodiments, sensor data from the environmental sensors 228 may affect whether or not an output from the navigation visualization component 210 is to be displayed, and/or whether certain actions are to be implemented by the navigation visualization component 210. For example, if traffic density is high and/or the environment has inclement, hazy, or otherwise compromised conditions in which visibility is compromised, then certain visualizations may or may not be generated, and an obstacle may or may not be characterized as a potential interfering obstacle. For instance, a same obstacle may be characterized as a potential interfering obstacle when that obstacle is within 200 feet of the ego vehicle 2 under compromised visibility conditions or conditions of high traffic density. That same obstacle may be characterized as a potential interfering obstacle only when that obstacle approaches to within 100 feet of the ego vehicle 2 under normal, uncompromised conditions or conditions of normal traffic density. That is, a same obstacle may be required to be within a closer distance to the ego vehicle 2 in order to be inferred as a potential interfering obstacle under normal, uncompromised conditions or conditions of normal traffic density.

Additional sensors 232 can also be included as may be appropriate for a given implementation of collision avoidance system 200. The sensors 152 may be configured to detect and/or alert for any indications of anomalous behavior and/or potential interfering obstacles.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to detect potential interfering obstacles or generate visual representations, for processor 206 as well as any other suitable information. Memory 208 can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, navigation visualization component 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up obstacle detection component 203 and/or navigation visualization component 210.

Communication component 201 includes either or both a wireless transceiver component 202 with an associated antenna 205 and a wired I/O interface 204 with an associated hardwired data port (not illustrated). As this example illustrates, communications with navigation visualization component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by navigation visualization component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

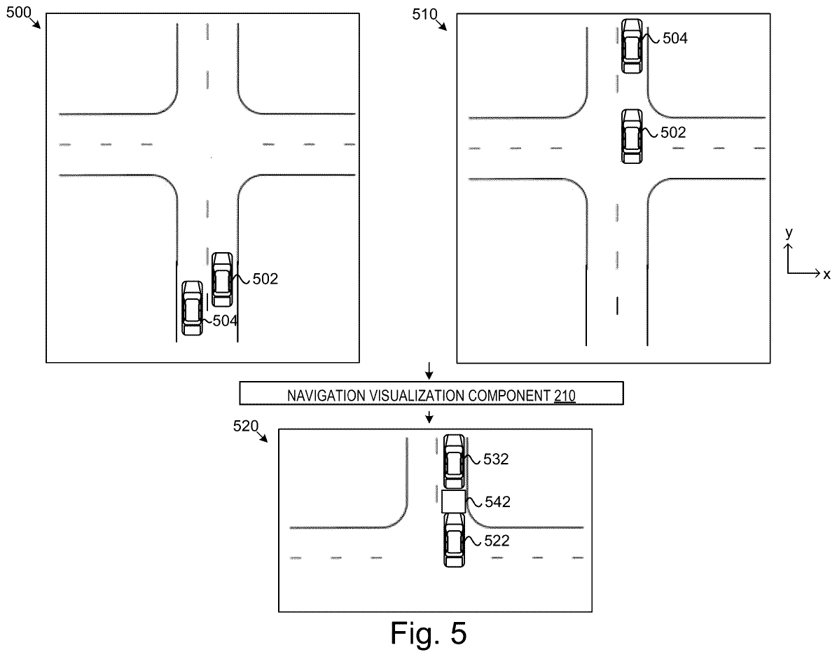

FIGS. 4 and 5 illustrate example implementations of the navigation visualization component 210. In some embodiments, as illustrated in FIGS. 4-5, the navigation visualization component 210 obtains inputs of sensor data, characterizes an entity within or corresponding to the sensor data as a potentially interfering obstacle, and generates a visual representation of an environment of the ego vehicle 2. The visual representation includes the potential interfering obstacle or a representation thereof, any navigation actions or predicted navigation actions of the potential interfering obstacle, a visual representation of the ego vehicle 2, and/or any planned navigation actions of the ego vehicle 2 in response to the potential interfering obstacle.

In some embodiments, the principles in FIGS. 4-5 may be applied in conjunction with FIG. 3. In FIG. 4, the navigation visualization component 210 obtains scenarios 400 and 410. The scenario 400 includes a frame or other portion of sensor data, that captures or otherwise includes an ego vehicle 402 and a potential interfering obstacle 404 (e.g., another vehicle). In some embodiments, the ego vehicle 402 may be implemented as the ego vehicle 2. In the scenario 410, which may include a different, subsequent frame or other portion of sensor data, the potential interfering obstacle 404 is approaching closer to the ego vehicle 402 and changing a lane to cut in front of the ego vehicle 402.

From inputs of the scenarios 400 and 410, the navigation visualization component 210 generates a visual representation 420 which includes an ego vehicle representation 422 of the ego vehicle 402, an obstacle representation 432 of the potential interfering obstacle 404, and a navigation representation 452 of an action or intended action of the ego vehicle 402. Here, the navigation representation 452 includes chevrons indicating that the ego vehicle 402 intends to slow down to permit the potential interfering obstacle 404 to merge into a same lane. In other embodiments, the navigation representation 452 may include chevrons indicating that the ego vehicle 402 intends to speed up, if the ego vehicle 402 does indeed plan to speed up.

In FIG. 5, the navigation visualization component 210 obtains scenarios 500 and 510. The scenario 500 includes a frame or other portion of sensor data, that captures or otherwise includes an ego vehicle 502 and a potential interfering obstacle 504 (e.g., another vehicle). In some embodiments, the ego vehicle 502 may be implemented as the ego vehicle 2. In the scenario 510, which may include a different, subsequent frame or other portion of sensor data, the potential interfering obstacle 504 is illustrated as having cut in front of the ego vehicle 502.

From inputs of the scenarios 500 and 510, the navigation visualization component 210 generates a visual representation 520 which includes a representation 522 of the ego vehicle 502, a representation 532 of the potential interfering obstacle 504, and a navigation representation 542 of an action or intended action of the ego vehicle 502. Here, the navigation representation 542 includes a representation or symbol such as a gate, manifested as a bar or a rectangle, indicating that the ego vehicle 502 is, or is intending to, slow down and/or to maintain at least a threshold distance with the potential interfering obstacle 504.

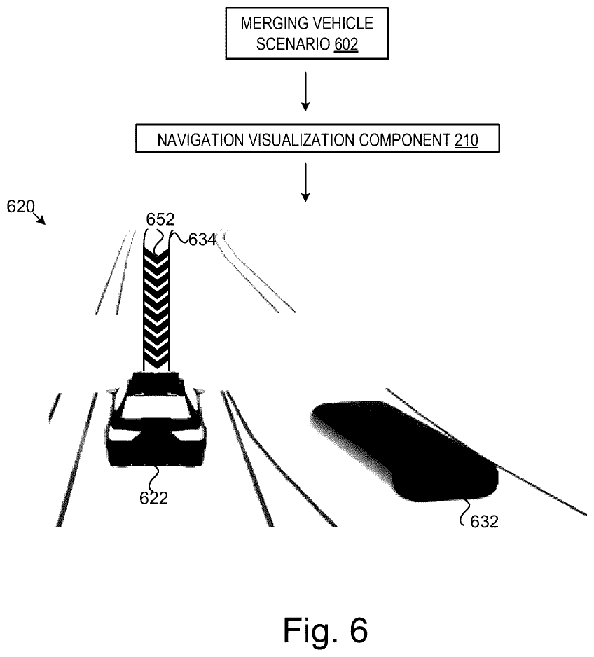

FIG. 6 illustrates an implementation of the navigation visualization component 210 generating a visual representation 620 corresponding to a merging vehicle scenario 602. In the merging vehicle scenario 602, a potential interfering obstacle, represented as an obstacle representation 632, is predicted to, and/or has indicated a plan to, merge onto a road (e.g., a lane) currently occupied by the ego vehicle 2, represented by an ego vehicle representation 622. In some embodiments, the prediction of merging by the potential interfering obstacle, or otherwise receiving an indication of a plan to merge from the potential interfering obstacle, may be performed by one or more computing components associated with the ego vehicle 2, such as the navigation detection component 203. In FIG. 6, the visual representation 620 may include the ego vehicle representation 622, the obstacle representation 632, a trajectory representation 634 indicating a predicted or planned navigation trajectory of the ego vehicle 2, and a navigation representation 652 indicating a planned navigation action of the ego vehicle 2. Here, the navigation representation 652 indicates that the planned navigation action of the ego vehicle 2 is to slow down to permit the potential interfering obstacle to merge, as indicated by chevrons. The navigation representation 652 may be integrated with or otherwise depicted within the trajectory representation 634. In some embodiments, certain portions of the obstacle representation 632 may be emphasized, such as portions of interest being highlighted. The emphasized portion may correspond to a relative position of the potential interfering obstacle with respect to the ego vehicle 2, and/or a nearest surface of the potential interfering obstacle facing the ego vehicle 2. Here, the emphasized portion may include a left surface of the obstacle representation 632. In some embodiments, the emphasized portion may change as the relative position of the potential interfering obstacle changes. For example, if the potential interfering obstacle were previously behind the ego vehicle 2 and has moved to a side of the ego vehicle 2, the emphasized portion of the potential interfering obstacle may be changed to a side of the potential interfering obstacle, rather than a front of the potential interfering obstacle.

FIG. 6 illustrates an implementation of the navigation visualization component 210 generating a visual representation 620 corresponding to a merging vehicle scenario 602. In the merging vehicle scenario 602, a potential interfering obstacle, represented as an obstacle representation 632, is predicted to, and/or has indicated a plan to, merge onto a road (e.g., a lane) currently occupied by the ego vehicle 2, represented by an ego vehicle representation 622. In some embodiments, the prediction of merging by the potential interfering obstacle, or otherwise receiving an indication of a plan to merge from the potential interfering obstacle, may be performed by one or more computing components associated with the ego vehicle 2, such as the navigation detection component 203. In FIG. 6, the visual representation 620 may include the ego vehicle representation 622, the obstacle representation 632, a trajectory representation 634 indicating a predicted or planned navigation trajectory of the ego vehicle 2, and a navigation representation 652 indicating a planned navigation action of the ego vehicle 2. Here, the navigation representation 652 indicates that the planned navigation action of the ego vehicle 2 is to slow down to permit the potential interfering obstacle to merge, as indicated by chevrons. The navigation representation 652 may be integrated with or otherwise depicted within boundaries of the trajectory representation 634. In some embodiments, characteristics of the navigation representation 652, such as a size and/or a number of the chevrons, may be indicative of an extent of a planned decrease and/or duration of the planned decrease in speed.

In some embodiments, certain portions of the obstacle representation 632 may be emphasized, such as portions of interest being highlighted. The emphasized portion may correspond to a relative position of the potential interfering obstacle with respect to the ego vehicle 2, and/or a nearest surface of the potential interfering obstacle facing the ego vehicle 2. Here, the emphasized portion may include a left surface of the obstacle representation 632.

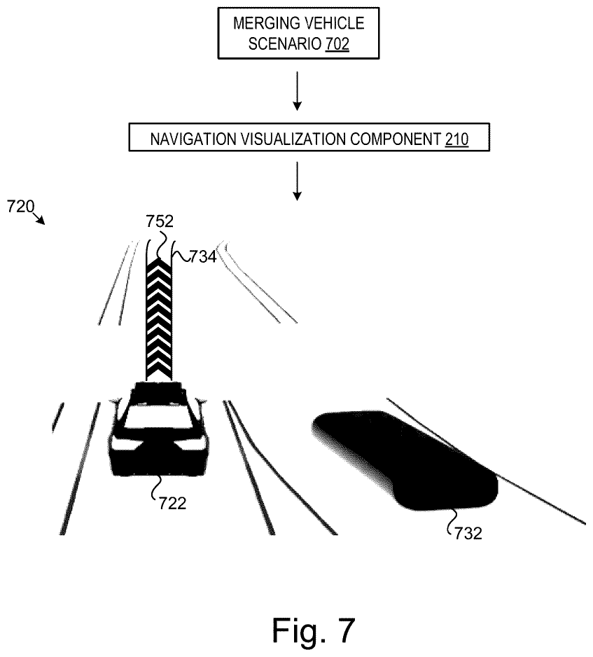

FIG. 7 illustrates an implementation of the navigation visualization component 210 generating a visual representation 720 corresponding to a merging vehicle scenario 702. In the merging vehicle scenario 702, a potential interfering obstacle, represented as an obstacle representation 732, is predicted to, and/or has indicated a plan to, merge onto a road (e.g., a lane) currently occupied by the ego vehicle 2, represented by an ego vehicle representation 722. In some embodiments, the prediction of merging by the potential interfering obstacle, or otherwise receiving an indication of a plan to merge from the potential interfering obstacle, may be performed by one or more computing components associated with the ego vehicle 2, such as the navigation detection component 203. In FIG. 7, the visual representation 720 may include the ego vehicle representation 722, the obstacle representation 732, a trajectory representation 734 indicating a predicted or planned navigation trajectory of the ego vehicle 2, and a navigation representation 752 indicating a planned navigation action of the ego vehicle 2. Here, the navigation representation 752 indicates that the planned navigation action of the ego vehicle 2 is to speed up to remain in front of the potential interfering obstacle, as indicated by chevrons. The navigation representation 752 may be integrated with or otherwise depicted within boundaries of the trajectory representation 734. In some embodiments, characteristics of the navigation representation 752, such as a size and/or a number of the chevrons, may be indicative of an extent of a planned increase and/or duration of the planned increase in speed.

In some embodiments, certain portions of the obstacle representation 732 may be emphasized, such as portions of interest being highlighted. The emphasized portion may correspond to a relative position of the potential interfering obstacle with respect to the ego vehicle 2, and/or a nearest surface of the potential interfering obstacle facing the ego vehicle 2. Here, the emphasized portion may include a left surface of the obstacle representation 732.

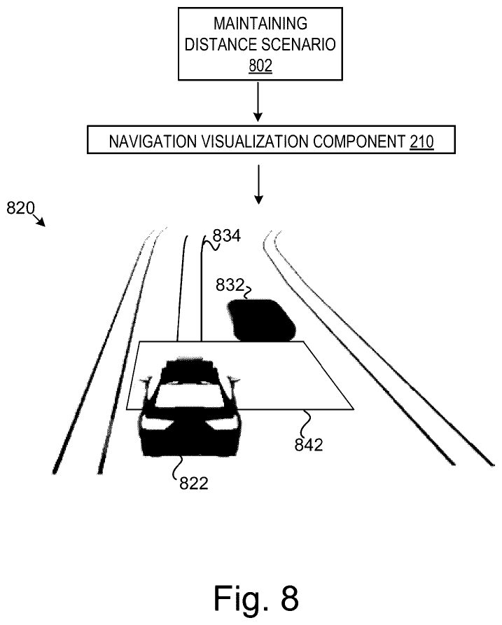

FIG. 8 illustrates an implementation of the navigation visualization component 210 generating a visual representation 820 corresponding to a maintaining distance scenario 802. In the maintaining distance scenario 802, a potential interfering obstacle, represented as an obstacle representation 832, is currently in front of and to a side of the ego vehicle. The ego vehicle 2 may be represented by an ego vehicle representation 822. In FIG. 8, the visual representation 820 may include the ego vehicle representation 822, the obstacle representation 832, a trajectory representation 834 indicating a predicted or planned navigation trajectory of the ego vehicle 2, and a navigation representation 842 indicating a planned navigation action of the ego vehicle 2. Here, the navigation representation 842 indicates that the planned navigation action of the ego vehicle 2 is to maintain a distance from the potential interfering obstacle in case the potential interfering obstacle merges into a same lane as the ego vehicle 2. The navigation representation 842 may include a gate representation such as a slow gate. Therefore, the navigation representation 842 may also include a planned navigation action with respect to a characteristic or predicted characteristic of a potential interfering obstacle, such as a position or a predicted position of the potential interfering obstacle. In some embodiments, boundaries or borders of the navigation representation 842 may correspond to front and rear extremities of the ego vehicle 2 and of the potential interfering obstacle, respectively. In some embodiments, characteristics of the navigation representation 842, such as a degree of shading, or a degree or a size of a gradient, of the navigation representation 842, may be indicative of an extent of a planned deceleration.

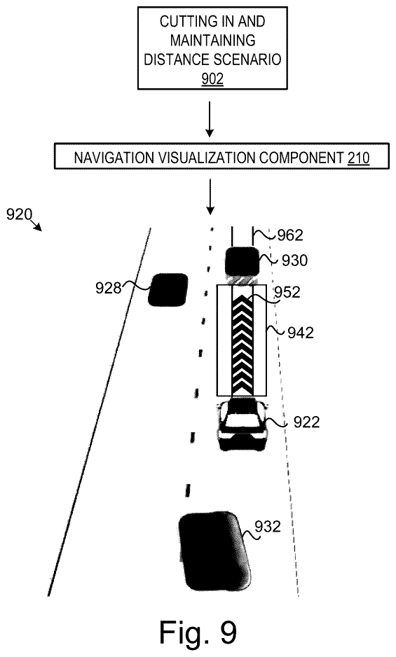

FIG. 9 illustrates an implementation of the navigation visualization component 210 generating a visual representation 920 corresponding to a cutting in and maintaining distance scenario 902. FIG. 9 illustrates potentially conflicting or interfering navigation decisions of the ego vehicle 2, which is represented by an ego vehicle representation 922. In the cutting in and maintaining distance scenario 902, a first potential interfering obstacle, represented as a first obstacle representation 932, is currently behind the ego vehicle 2. A second potential interfering obstacle, represented as a second obstacle representation 930, is currently in front of the ego vehicle 2. A third obstacle, represented as a third obstacle representation 928, may or may not be characterized as a potential interfering obstacle, and is currently to a side of the ego vehicle 2.

In FIG. 9, the visual representation 920 may include the ego vehicle representation 922, the first obstacle representation 932, the second obstacle representation 930, and/or the third obstacle representation 928. The visual representation 920 may further include a trajectory representation 962 indicating a predicted or planned navigation trajectory of the ego vehicle 2. The visual representation 920 may further include a first navigation representation 952 indicating a planned navigation action of the ego vehicle 2 in response to the first potential interfering obstacle or the third obstacle. The visual representation 920 may further include a second navigation representation 942 indicating a planned navigation action of the ego vehicle 2 in response to the second potential interfering obstacle.

Here, the first navigation representation 952 indicates that the planned navigation action of the ego vehicle 2 is to speed up in response to navigation actions, or predicted or planned navigation actions, by the first potential interfering obstacle or the third obstacle. For example, the ego vehicle 2 may speed up in order to attempt to prevent the first potential interfering obstacle from cutting in front of the ego vehicle 2. Meanwhile, the second navigation representation 942 indicates that the planned navigation action of the ego vehicle 2 is to slow down and/or maintain at least a threshold distance with the second potential interfering obstacle. Thus, FIG. 9 illustrates potentially conflicting navigation actions by the ego vehicle 2.

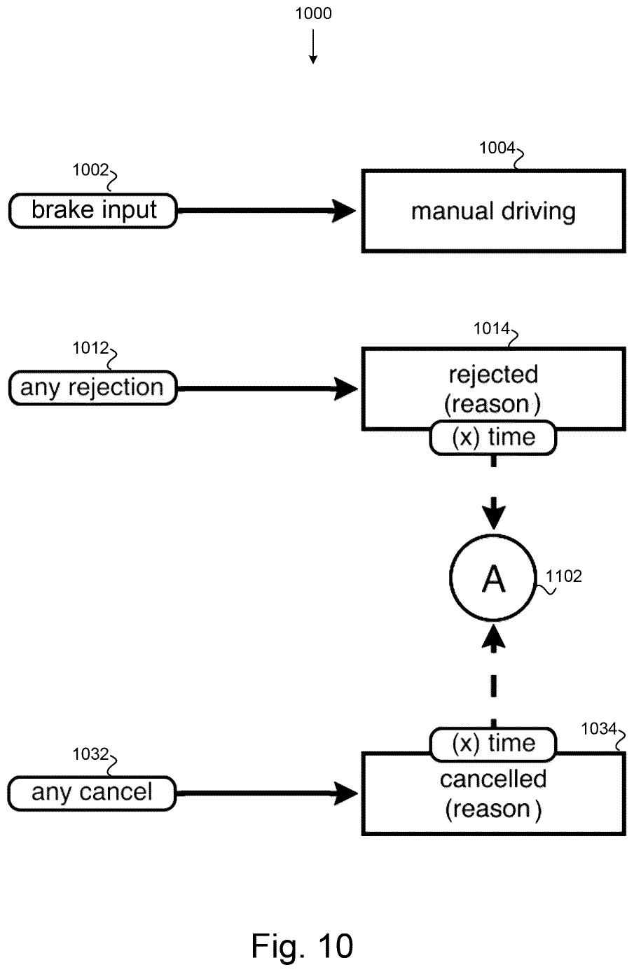

FIG. 10 is an example flowchart 1000 illustrating navigation actions and generating of visual representations in various navigation scenarios, such as non-linear events, performed by one or more computing components of the ego vehicle 2 such as the navigation visualization system 200. In FIGS. 10-13 as well as in preceding figures, it is understood that any tasks attributed to the ego vehicle 2 and/or the navigation visualization system 200 of the ego vehicle 2 may be additionally or alternatively performed by other computing components of the ego vehicle 2.

In FIG. 10, a brake input 1002 may include a manual brake input from an operator. In response to receiving the brake input 1002, the navigation visualization system 200 of the ego vehicle 2 may activate a manual mode 1004, which may switch off an adaptive cruise control mode or one or more other at least partially autonomous features or modes of the ego vehicle 2. The ego vehicle 2 may perform manual driving or navigation actions while in the manual mode 1004.

In other embodiments, the navigation visualization system 200 may output a rejection 1012 in response to a received request by an operator. The rejection 1012 may be due to infeasibility, lack of safety, and/or other reasons. For example, the operator may request a lane change to the right by pressing a right blinker. If the ego vehicle 2 is already in a right most lane, then such a request would be infeasible and would be rejected. Upon the output of the rejection 1012, the navigation visualization system 200 may output an explanation 1014 including a reason for the rejection 1012. The explanation 1014 may be displayed on a human machine interface (HMI) in various locations of the ego vehicle, such as on a console (e.g., central console), dashboard, a front display, and/or a rear display. Following the rejection 1012, the navigation visualization system 200 may revert to a default mode 1102, which may represent a mode of navigating to a planned destination with no operator input.

In other embodiments, the navigation visualization system 200 may output a cancellation 1032 in response to a received request and/or an attempted operation. For example, the ego vehicle 2 may be planning to switch to a target lane, but the target lane may still be occupied. After a threshold period of time of being unable to perform the planned operation due to safety and/or infeasibility, the navigation visualization system 200 may output the cancellation 1032. In response to outputting the cancellation 1032, the navigation visualization system 200 may output an explanation 1034 including a reason for the cancellation 1032. The explanation 1034 may be displayed on a human machine interface (HMI) in various locations of the ego vehicle, such as on a console (e.g., central console), dashboard, a front display, and/or a rear display. Following the cancellation 1032, the navigation visualization system 200 may revert to the default mode 1102.

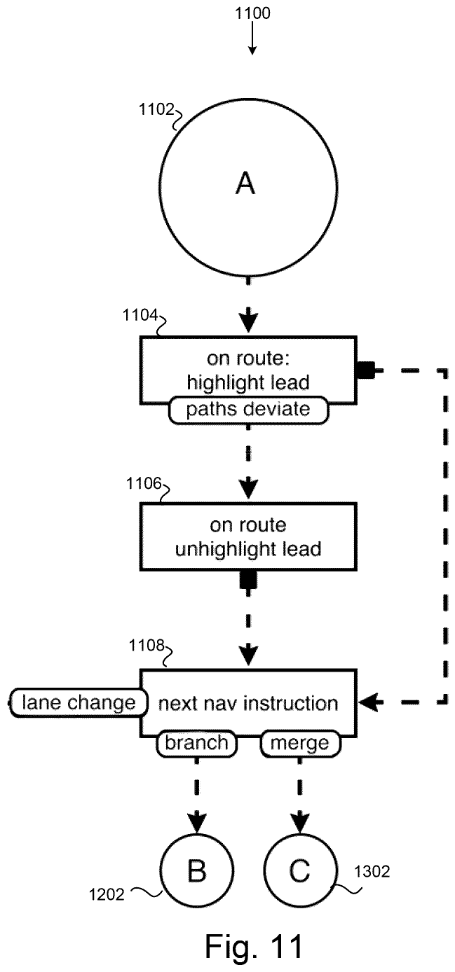

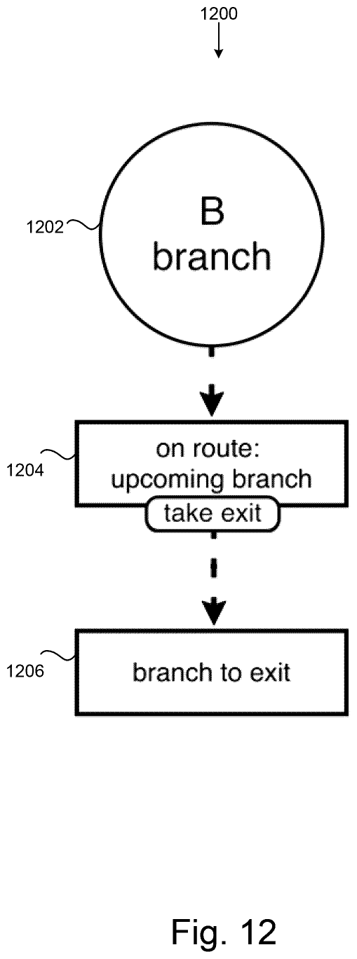

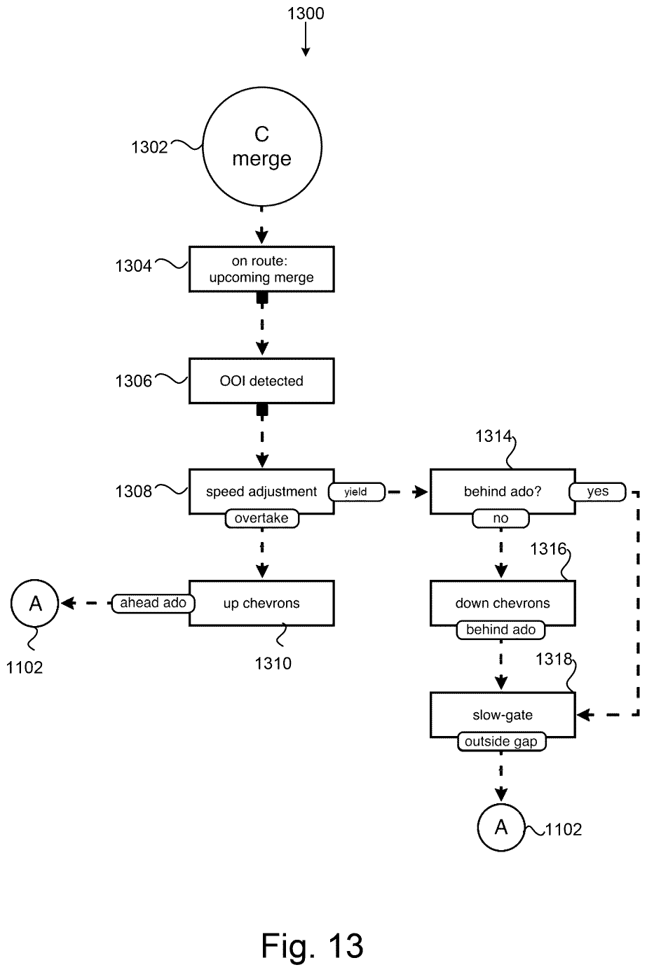

FIG. 11 is an example flowchart 1100 illustrating navigation actions and generating of visual representations within the default mode 1102, performed by one or more computing components of the ego vehicle 2 such as the navigation visualization system 200. In FIG. 11, the navigation visualization system 200 may initially be operating in the default mode 1102. If the ego vehicle 2 is following a route, the navigation visualization system 200 may emphasize, in step 1104, a lead vehicle directly in front of the ego vehicle 2. For example, the navigation visualization system 200 may highlight at least a rear portion of the lead vehicle. If the ego vehicle 2 is deviating from a path of the route, in step 1106, the navigation visualization system 200 may remove an emphasis from the lead vehicle. Examples of deviating include a lane change, a branching, or a merging or forking operation. The navigation visualization system 200 may transition either from step 1104 or from step 1106 to step 1108. In step 1108, the navigation visualization system 200 may receive a subsequent navigation command which relates, for example, to a lane change, a branching, or a merging or forking operation. In an event of receiving a navigation command corresponding to a branching operation, the navigation visualization system 200 may switch to a branching mode 1202, as described in FIG. 12 in more detail. In an event of receiving a navigation command corresponding to a merging operation, the navigation visualization system 200 may switch to a merging mode 1302, as described in FIG. 13 in more detail.

FIG. 12 is an example flowchart 1200 illustrating navigation actions and generating of visual representations within the branching mode 1202, performed by one or more computing components of the ego vehicle 2 such as the navigation visualization system 200. In the branching mode 1202, the navigation visualization system 200 may deviate from a current path in step 1204, and follow an upcoming branching path in step 1206. Once branching is completed, the navigation visualization system 200 may return to the default mode 1102.

FIG. 13 is an example flowchart 1300 illustrating navigation actions and generating of visual representations within the merging mode 1302, performed by one or more computing components of the ego vehicle 2 such as the navigation visualization system 200. In the merging mode 1302, the navigation visualization system 200 may be planning an upcoming merging operation in step 1304. In some embodiments, a merging operation may be applicable to the ego vehicle 2 merging, or the ego vehicle 2 permitting a potential interfering obstacle to merge. In step 1306, the navigation visualization system 200 may detect an object of interest, such as a potential interfering obstacle. In step 1308, the navigation visualization system 200 may perform a speed adjustment of accelerating in an effort to overtake the object of interest or decelerating in an effort to yield to the object of interest. In step 1310, in response to the navigation visualization system 200 accelerating, the navigation visualization system 200 may output a visual representation that includes up chevrons that indicate the acceleration. If the ego vehicle 2 is ahead of the object of interest, then the navigation visualization system 200 may return to the default mode 1102.

In decision 1314, in response to the navigation visualization system 200 decelerating, the navigation visualization system 200 may determine whether the ego vehicle 2 is behind the object of interest. If not, the navigation visualization system 200, in step 1316, may output a first visual representation that includes down chevrons that indicate further deceleration until the ego vehicle 2 is behind the object of interest. Once the ego vehicle 2 is behind the object of interest, the navigation visualization system 200, in step 1318, may output a second visual representation of a slow gate indicating that the ego vehicle 2 is intending to maintain at least a threshold distance from the object of interest. After step 1318, the navigation visualization system 200 may return to the default mode 1102.

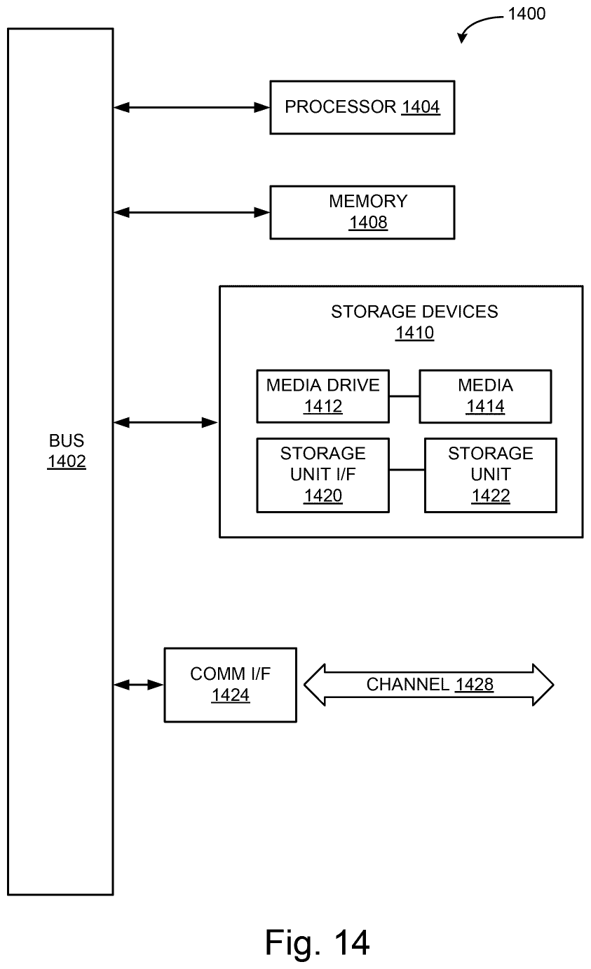

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 14. Various embodiments are described in terms of this example-computing component 1400. After reading this description, it will become apparent to a person skilled in the relevant art how to implement the application using other computing components or architectures.

Referring now to FIG. 14, computing component 1400 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1400 might also represent computing capabilities embedded within or otherwise available to a given device. For example, a computing component might be found in other electronic devices such as, for example, portable computing devices, and other electronic devices that might include some form of processing capability.

Computing component 1400 might include, for example, one or more processors, controllers, control components, or other processing devices. This can include a processor, and/or any one or more of the components. Processor 1404 might be implemented using a general-purpose or special-purpose processing engine such as, for example, a microprocessor, controller, or other control logic. Processor 1404 may be connected to a bus 1402. However, any communication medium can be used to facilitate interaction with other components of computing component 1400 or to communicate externally.

Computing component 1400 might also include one or more memory components, simply referred to herein as main memory 1408. For example, random access memory (RAM) or other dynamic memory, might be used for storing information and instructions to be executed by processor 1404. Main memory 1408 might also be used for storing temporary variables or other intermediate information during execution of instructions to be executed by processor 1404. Computing component 1400 might likewise include a read only memory (“ROM”) or other static storage device coupled to bus 1402 for storing static information and instructions for processor 1404.

The computing component 1400 might also include one or more various forms of information storage mechanism 1410, which might include, for example, a media drive 1412 and a storage unit interface 1420. The media drive 1412 might include a drive or other mechanism to support fixed or removable storage media 1414. For example, a hard disk drive, a solid-state drive, a magnetic tape drive, an optical drive, a compact disc (CD) or digital video disc (DVD) drive (R or RW), or other removable or fixed media drive might be provided. Storage media 1414 might include, for example, a hard disk, an integrated circuit assembly, magnetic tape, cartridge, optical disk, a CD or DVD. Storage media 1414 may be any other fixed or removable medium that is read by, written to or accessed by media drive 1412. As these examples illustrate, the storage media 1414 can include a computer usable storage medium having stored therein computer software or data.

In alternative embodiments, information storage mechanism 1410 might include other similar instrumentalities for allowing computer programs or other instructions or data to be loaded into computing component 1400. Such instrumentalities might include, for example, a fixed or removable storage unit 1422 and an interface 1420. Examples of such storage units 1422 and interfaces 1420 can include a program cartridge and cartridge interface, a removable memory (for example, a flash memory or other removable memory component) and memory slot. Other examples may include a PCMCIA slot and card, and other fixed or removable storage units 1422 and interfaces 1420 that allow software and data to be transferred from storage unit 1422 to computing component 1400.

Computing component 1400 might also include a communications interface 1424. Communications interface 1424 might be used to allow software and data to be transferred between computing component 1400 and external devices. Examples of communications interface 1424 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1424 may be carried on signals, which can be electronic, electromagnetic (which includes optical) or other signals capable of being exchanged by a given communications interface 1424. These signals might be provided to communications interface 1424 via a channel 1428. Channel 1428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1408, storage unit 1420, media 1414, and channel 1428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1400 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree. For example, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
one or more sensors configured to obtain sensor data of an ego vehicle and of an obstacle during operation of the ego vehicle, the sensor data comprising navigation characteristics of the ego vehicle and the obstacle;
one or more processors;
a memory storing instructions that, when executed by the one or more processors, cause the system to perform:
selectively characterizing the obstacle as a potential interfering obstacle based on the sensor data; and
in response to characterizing the obstacle as a potential interfering obstacle:
determining an intended action of the ego vehicle in response to the potential interfering obstacle;
generating a visual representation of an environment of the ego vehicle, wherein the visual representation comprises a representation of the intended action of the ego vehicle; and
populating the visual representation on an interface, wherein the interface is associated with the ego vehicle or associated with an occupant of the ego vehicle.

2. The system of claim 1, wherein the navigation characteristics comprising a relative position, a relative velocity, or a relative heading of the ego vehicle with respect to the obstacle.

3. The system of claim 1, wherein the potential interfering obstacle is characterized based on an inferred action or a historical behavior of the potential interfering obstacle with respect to the ego vehicle.

4. The system of claim 1, wherein the visual representation comprises a representation of the ego vehicle and a representation of the potential interfering obstacle.

5. The system of claim 4, wherein the generating of the visual representation comprises determining a portion of the representation of the potential interfering obstacle to be emphasized based on a relative position of the potential interfering obstacle with respect to the ego vehicle and emphasizing the determined portion of the representation of the potential interfering obstacle.

6. The system of claim 1, wherein the intended action comprises a change in a velocity of the ego vehicle.

7. The system of claim 1, wherein the intended action comprises one or more navigation actions to maintain a threshold distance from the potential interfering obstacle.

8. The system of claim 1, wherein the generating of the visual representation comprises overlaying the visual representation onto existing sensor data illustrating the environment of the ego vehicle.

9. The system of claim 1, wherein the instructions that, when executed by the one or more processors, cause the system to perform:
at least partially autonomously implementing the intended action of the ego vehicle.

10. The system of claim 1, wherein the selectively characterizing of the obstacle as a potential interfering obstacle is based on a relative distance between the obstacle and the ego vehicle.

11. A vehicle control system, comprising:
a processor; and
a memory coupled to the processor to store instructions, which when executed by the processor, cause the processor to perform operations, the operations comprising:
obtaining sensor data from one or more sensors, the sensor data comprising navigation characteristics of an ego vehicle and an obstacle;
characterizing the obstacle as a potential interfering obstacle based on the sensor data; and
in response to characterizing the obstacle as a potential interfering obstacle:
determining an intended action of the ego vehicle in response to the potential interfering obstacle;
generating a visual representation of an environment of the ego vehicle, wherein the visual representation comprises a representation of the intended action of the ego vehicle; and
populating the visual representation on an interface, wherein the interface is associated with the ego vehicle or associated with an occupant of the ego vehicle.

12. The vehicle control system of claim 11, wherein the navigation characteristics comprising a relative position, a relative velocity, or a relative heading of the ego vehicle with respect to the obstacle.

13. The vehicle control system of claim 11, wherein the potential interfering obstacle is characterized based on an inferred action or a historical behavior of the potential interfering obstacle with respect to the ego vehicle.

14. The vehicle control system of claim 11, wherein the visual representation comprises a representation of the ego vehicle and a representation of the potential interfering obstacle.

15. The vehicle control system of claim 14, wherein the generating of the visual representation comprises determining a portion of the representation of the potential interfering obstacle to be emphasized based on a relative position of the potential interfering obstacle with respect to the ego vehicle and emphasizing the determined portion of the representation of the potential interfering obstacle.

16. The vehicle control system of claim 11, wherein the intended action comprises a change in a velocity of the ego vehicle.

17. The vehicle control system of claim 11, wherein the intended action comprises one or more navigation actions to maintain a threshold distance from the potential interfering obstacle.

18. The vehicle control system of claim 11, wherein the generating of the visual representation comprises overlaying the visual representation onto existing sensor data illustrating the environment of the ego vehicle.

19. The vehicle control system of claim 11, wherein the instructions that, when executed by the one or more processors, cause the system to perform:
at least partially autonomously implementing the intended action of the ego vehicle.

20. A non-transitory machine-readable medium having instructions stored therein, which when executed by a processor, cause the processor to perform operations, the operations comprising:
obtaining sensor data from one or more sensors, the sensor data comprising navigation characteristics of an ego vehicle and an obstacle;
characterizing the obstacle as a potential interfering obstacle based on the sensor data; and
in response to characterizing the obstacle as a potential interfering obstacle:
determining an intended action of the ego vehicle in response to the potential interfering obstacle;
generating a visual representation of an environment of the ego vehicle, wherein the visual representation comprises a representation of the intended action of the ego vehicle; and
populating the visual representation on an interface, wherein the interface is associated with the ego vehicle or associated with an occupant of the ego vehicle.
